(19) United States
(12) Patent Application Publication
(10) Pub. No.: US 2023/0029225 A1
(43) Pub. Date: Jan. 26, 2023

(54) BATTERY, IN PARTICULAR A THIN-FILM BATTERY, HAVING A NOVEL ENCAPSULATION SYSTEM

(71) Applicant: I-TEN, Dardilly (FR)

(72) Inventors: Fabien GABEN, Dardilly (FR); Ian CAYREFOURCQ, Villefontaine (FR); David GRUET, Thurins (FR); Claire SORRIANO, Lyon (FR)

(21) Appl. No.: 17/788,410

(22) PCT Filed: Dec. 23, 2020
(86) PCT No.: PCT/IB2020/062400

§ 371 Date: Jun. 23, 2022

(30) Foreign Application Priority Data
Dec. 24, 2019 (FR) 1915544
Dec. 24, 2019 (FR) 1915566

(51) Int. Cl. H01M 50/141; H01M 10/04; H01M 50/126; H01M 50/176; H01M 6/40

(52) U.S. Cl. CPC H01M 50/141; H01M 10/0436; H01M 50/126; H01M 50/176; H01M 6/40; H01M 10/0525

(57) ABSTRACT

Thin-film batteries that include a novel encapsulation system.

### CROSS-REFERENCE TO RELATED APPLICATIONS

The present application is a National Stage Application of PCT International Application No. PCT/IB2020/062400 (filed on Dec. 23, 2020), under 35 U.S.C. § 371, which claims priority to French Patent Application No. 1915544 (filed on Dec. 24, 2019), French Patent Application No. 1915566 (filed on Dec. 24, 2019), which are each hereby incorporated by reference in their complete respective entireties.

### TECHNICAL FIELD

The present invention relates to batteries, in particular to thin-film batteries, and more particularly to the encapsulation systems protecting same. The invention more particularly relates to the field of lithium-ion batteries, which can be encapsulated in this way. The invention further relates to a novel method for manufacturing thin-film batteries, having a novel architecture and encapsulation that gives them a particularly low self-discharge rate and a longer life.

### BACKGROUND

Some types of batteries, an in particular some types of thin-film batteries, need to be encapsulated in order to have a long life because oxygen and moisture cause degradation thereto. In particular, lithium-ion batteries are very sensitive to moisture. The market demands a product life of more than 10 years; an encapsulation must thus be provided to guarantee this life.

Thin-film lithium-ion batteries are multi-layer stacks comprising electrode and electrolyte layers typically between about one μm and about ten μm thick. They can comprise a stack of a plurality of unit cells. These batteries are seen to be sensitive to self-discharge. Depending on the positioning of the electrodes, in particular the proximity of the edges of the electrodes for multi-layer batteries and the cleanness of the cuts, a leakage current can appear at the ends, i.e. a creeping short-circuit which reduces battery performance. This phenomenon is exacerbated if the electrolyte film is very thin.

These solid-state thin-film lithium-ion batteries usually use anodes having a lithium metal layer. The volume of the anode materials is seen to vary significantly during charge and discharge cycles of the battery. More specifically, during a charge and discharge cycle, part of the lithium metal is transformed into lithium ions, which are inserted into the structure of the cathode materials, which is accompanied by a reduction in the volume of the anode. This cyclic variation in volume can deteriorate the mechanical and electrical contacts between the electrode and electrolyte layers. This reduces battery performance during its life.

The cyclic variation in the volume of the anode materials also induces a cyclic variation in the volume of the battery cells. It thus generates cyclic stresses on the encapsulation system, which are liable to initiate cracks causing a loss of imperviousness (or even a loss of integrity) of the encapsulation system. This phenomenon is yet another cause of reduced battery performance during the life thereof.

More specifically, the active materials of lithium-ion batteries are very sensitive to air and in particular to moisture. Mobile lithium ions react spontaneously with traces of water to form LiOH, resulting in calendar ageing of the batteries. All lithium ion-conductive electrolytes and insertion materials are non-reactive to moisture. By way of example, Li₄Ti₅O₁₂ does not deteriorate when in contact with the atmosphere or traces of water. By contrast, as soon as it is filled with lithium in the form Li₄₊ₓTi₅O₁₂, where x>0, the inserted lithium surplus (x) is sensitive to the atmosphere and reacts spontaneously with traces of water to form LiOH. The reacted lithium is thus no longer available for storing electricity, resulting in a loss of capacity of the battery.

To prevent exposure of the active materials of the lithium-ion battery to air and water and to prevent this type of ageing, it must be protected with an encapsulation system. Numerous encapsulation systems for thin-film batteries are described in the literature.

U.S. Patent Publication No. 2002/0071989 describes an encapsulation system for a solid-state thin-film battery comprising a stack of a first layer of a dielectric material selected from among alumina (Al₂O₃), silica (SiO₂), silicon nitride (Si₃N₄), silicon carbide (SiC), tantalum oxide (Ta₂O₅) and amorphous carbon, a second layer of a dielectric material and an impervious sealing layer disposed on the second layer and covering the entire battery.

U.S. Pat. No. 5,561,004 describes a plurality of systems for protecting a thin-film lithium-ion battery. A first proposed system comprises a parylene layer covered with an aluminium film deposited on the active components of the battery. However, this system for protecting against air and water vapour diffusion is only effective for about a month. A second proposed system comprises alternating layers of parylene (500 nm thick) and metal (about 50 nm thick). The document states that it is preferable to coat these batteries again with an ultraviolet-cured (UV-cured) epoxy coating to reduce the speed at which the battery is degraded by atmospheric elements.

The Applicant has also proposed, in International Patent Publication No. WO 2019/215410, various examples of layers, intended to form anode and cathode contact members respectively. In the first example, a first thin layer is deposited by ALD and is in particular metallic. Moreover, a second layer of silver-filled epoxy resin is provided. In the second example, the first layer is a graphite-filled material, whereas the second layer comprises copper metal obtained from a nanoparticle-filled ink.

According to the prior art, most lithium-ion batteries are encapsulated in metallised polymer foils (called “pouches”) enclosed around the battery cell and heat-sealed at the connector tabs. These packagings are relatively flexible and the positive and negative connections of the battery are thus embedded in the heat-sealed polymer that was used to seal the packaging around the battery. However, this weld between the polymer foils is not totally impervious to atmospheric gases, since the polymers used to heat-seal the battery are relatively permeable to atmospheric gases. Permeability is seen to increase with the temperature, which accelerates ageing.

However, the surface area of these welds exposed to the atmosphere remains very small, and the rest of the packaging is formed by aluminium foils sandwiched between these polymer foils. In general, two aluminium foils are combined to minimise the effects of the presence of holes, which constitute defects in each of these aluminium foils. The probability of two defects on each of the strips being aligned is greatly reduced.

These packaging technologies guarantee a calendar life of about 10 to 15 years for a 10 Ah battery with a 10×20 cm² surface area, under normal conditions of use. If the battery is exposed to a high temperature, this life can be reduced to less than 5 years, which is insufficient for many applications. Similar technologies can be used for other electronic components, such as capacitors and active components.

### SUMMARY

As a result, there is a need for systems and methods for encapsulating thin-film batteries and other electronic components that protect the component from air, moisture and the effects of temperature. The encapsulation system must be impervious and hermetically-sealed, it must completely enclose and cover the component or battery, and it must also allow the edges of electrodes of opposite polarities to be galvanically separated in order to prevent any creeping short-circuit.

One purpose of the present invention is to overcome, at least in part, the aforementioned drawbacks of the prior art.

Another purpose of the present invention is to propose lithium-ion batteries with a very long life and a low self-discharge rate.

The encapsulation system according to the invention is advantageously of the stiff type. The battery cells are stiff and dimensionally stable due to the initial choice of materials. As a result, the encapsulation system obtained according to the invention is effective.

The invention provides for producing an encapsulation system that can be and that is advantageously deposited in a vacuum. Batteries according to the invention do not contain polymers; they can, however, contain ionic liquids. More specifically, they are either solid-state or of the “quasi-solid state” type, in which case they include a nano-confined ionic liquid-based electrolyte. From an electrochemical point of view, this nano-confined liquid electrolyte behaves like a liquid, insofar as it provides good mobility to the cations conducted thereby. From a structural point of view, this nano-confined liquid electrolyte does not behave like a liquid, since it remains nano-confined and can no longer escape its prison even when treated in a vacuum and/or at a high temperature.

Batteries according to the invention, which contain a nano-confined ionic liquid-based electrolyte, can thus undergo vacuum and/or vacuum and high-temperature treatments for the encapsulation thereof. In order to carry out impregnation before encapsulation, the edges of the layers can be exposed by cutting; after impregnation, these edges are closed off by making the electrical contact. The method according to the invention is also well suited for covering mesoporous surfaces.

The method according to the invention is also well suited for covering mesoporous surfaces.

At least one of the above purposes is achieved through at least one of the objects according to the invention as described hereinbelow.

The present invention provides as a first object a battery comprising:
at least one unit cell, said unit cell successively comprising an anode current-collecting substrate, an anode layer, a layer of an electrolyte material or of a separator impregnated with an electrolyte, a cathode layer, and a cathode current-collecting substrate, bearing in mind that in the case whereby said battery comprises a plurality of unit cells, the second is placed on top of the first in the indicated order for the layers, and so forth,
an encapsulation system covering at least part of the outer periphery of said unit cell, or of all of the unit cells where a plurality thereof are present, the encapsulation system comprising:
   optionally, a first cover layer, preferably chosen from among parylene, parylene F, polyimide, epoxy resins, silicone, polyamide, sol-gel silica, organic silica and/or a mixture thereof, deposited on the battery,
   optionally, a second cover layer consisting of an electrically insulating material, deposited by atomic layer deposition on the battery or on the first cover layer,
at least one anode contact member, intended to make the electrical contact between at least the unit cell and an external conductive element, said battery comprising a first contact surface defining at least one anode connection zone,
and at least one cathode contact member intended to make the electrical contact with an external conductive element, said battery comprising a second contact surface defining at least one cathode connection zone,

said battery being characterised in that the encapsulation system further comprises:
at least a third impervious cover layer, having a water vapour permeance (WVTR) of less than 10⁻⁵ g/m²·d, this third cover layer being made of a ceramic material and/or a low melting point glass, preferably a glass with a melting point below 600° C., said layer being deposited at the outer periphery of the battery or of the first cover layer, with the understanding that when said second cover layer is present, a succession of said second cover layer and said third cover layer can be repeated z times, where z≥1, and deposited at the outer periphery of at least the third cover layer, and with the understanding that the last layer of the encapsulation system is said impervious cover layer, having a water vapour permeance (WVTR) of less than 10⁻⁵ g/m²·d, which is made of a ceramic material and/or a low melting point glass.

According to other features of the battery according to the invention, which may be taken in isolation or according to any technically compatible feature:
the third impervious cover layer, preferably having a water vapour permeance (WVTR) of less than 10⁻⁵ g/m²·d, has a thickness comprised between 1 μm and 50 μm, more particularly between 1 μm and 10 μm, even more particularly between 1 μm and 5 μm, each of the anode and cathode contact members comprising:
a first electrical connection layer, disposed on at least the anode connection zone and at least the cathode connection zone, this first layer comprising a material filled with electrically conductive particles, preferably a polymeric resin and/or a material obtained by a sol-gel method, filled with electrically conductive particles and more preferably a graphite-filled polymeric resin, and
a second electrical connection layer comprising a metal foil disposed on the first layer of material filled with electrically conductive particles,
the metal foil is of the free-standing type, said metal foil being advantageously applied to said first electrical connection layer,
the metal foil is produced by rolling or electroplating,
   the thickness of the metal foil is comprised between 5 and 200 micrometres, this metal foil in particular being made from one of the following materials: nickel, stainless steel, copper, molybdenum, tungsten, vanadium, tantalum, titanium, aluminium, chromium and the alloys comprising same,
each of the anode and cathode contact members comprises a third layer comprising a conductive ink disposed on the second electrical connection layer.

The battery further comprises:
an electrical connection support, made at least in part of a conductive material, which support is provided near an end face of a unit cell,
electrical insulation means, enabling two distant regions of this connection support to be insulated from one another, these distant regions forming respective electrical connection paths,
said anode contact member enabling a first lateral face of each unit cell to be electrically connected to a first electrical connection path, whereas said cathode contact member enables a second lateral face of each unit cell to be electrically connected to a second electrical connection path,
the electrical connection support is of the single-layer type, in particular a metal grid or a silicon interlayer,
the electrical connection support comprises a plurality of layers disposed one below the other, this support being in particular of the printed circuit board type,
the impervious cover layer comprises a primary impervious cover layer, in particular not covering the anode and cathode contact members, respectively, as well as an additional impervious cover layer, in particular covering all or part of the contact members and in particular at least partially covering the electrical connection support.

The battery is a lithium-ion battery.

The battery is a solid-state lithium-ion battery.

The battery is designed and dimensioned to have a capacity of less than or equal to 1 mAh.

The battery is designed and dimensioned to have a capacity greater than 1 mA h.

The invention also relates to a method of manufacturing the above battery, said manufacturing method comprising:

a) supplying at least one anode current-collecting substrate foil coated with an anode layer, and optionally coated with a layer of an electrolyte material or a separator impregnated with an electrolyte, hereinafter referred to as an anode foil,

b) supplying at least one cathode current-collecting substrate foil coated with a cathode layer, and optionally coated with a layer of an electrolyte material or a separator impregnated with an electrolyte, hereinafter referred to as a cathode foil,

c) producing a stack (I) alternating at least one anode foil and at least one cathode foil to successively obtain at least one anode current-collecting substrate, at least one anode layer, at least one layer of an electrolyte material or of a separator impregnated with an electrolyte, at least one cathode layer, and at least one cathode current-collecting substrate,

d) heat treating and/or mechanically compressing the stack of alternating foils obtained in step c), so as to form a consolidated stack,

e) carrying out a step of encapsulating the consolidated stack, by depositing:
optionally, at least one first cover layer, preferably chosen from among parylene, parylene F, polyimide, epoxy resins, silicone, polyamide, sol-gel silica, organic silica and/or a mixture thereof, on the battery,
optionally, a second cover layer consisting of an electrically insulating material, deposited by atomic layer deposition on the battery or on the first cover layer, and
at least a third impervious cover layer, preferably having a water vapour permeance (WVTR) of less than 10⁻⁵ g/m²·d, this third cover layer being made of a ceramic material and/or a low melting point glass, preferably a glass with a melting point below 600° C., deposited at the outer periphery of the battery or of the first cover layer, with the understanding that this sequence of at least one second cover layer and at least one third cover layer can be repeated z times, where z 1, and deposited at the outer periphery of at least the third cover layer, and that the last layer of the encapsulation system is said impervious cover layer, having a water vapour permeance (WVTR) of less than 10⁻⁵ g/m²·d, which is made of a ceramic material and/or a low melting point glass,

f) making two cuts (Dn, D′n) so as to form a cut stack exposing at least the anode and cathode connection zones, and

g) producing anode contact members and cathode contact members.

According to other features of the process according to the invention, which may be taken in isolation or according to any technically compatible feature:
the production of the anode and cathode contact members comprises:

depositing, on at least the anode connection zone and at least the cathode connection zone, preferably on at least the contact surface comprising at least the anode connection zone and on at least the contact surface comprising at least the cathode connection zone, a first electrical connection layer made of a material filled with electrically conductive particles, said first layer preferably being made of polymeric resin and/or a material obtained by a sol-gel method filled with electrically conductive particles,

optionally, when said first layer is made of polymeric resin and/or a material obtained by a sol-gel method filled with electrically conductive particles, a drying step followed by a step of polymerising said polymeric resin and/or said material obtained by a sol-gel method, and

depositing, on the first layer, a second electrical connection layer disposed on the first electrical connection layer, said second electrical connection layer preferably being a metal foil or a metal ink, bearing in mind that in the latter case, said drying step can alternatively be carried out after the deposition of said second electrical connection layer,
the metal foil is formed by rolling, and then this metal foil thus formed is applied to the first electrical connection layer,
the metal foil is formed directly by electroplating, either ex situ or in situ with respect to the first metal connection layer.

The method comprises, after step g), on at least the anode and cathode connection zones of the battery, coated with the first and second electrical connection layer, a step h) of depositing a conductive ink,
the low melting point glass is chosen from among SiO₂—B₂O₃; Bi₂O₃—B₂O₃, ZnO—Bi₂O₃—B₂O₃, TeO₂—V₂O₅, and PbO—SiO₂,
the second cover layer is deposited by PECVD, preferably by HDPCVD or by ICP CVD at low temperature,
the second cover layer comprises oxides and/or nitrides and/or Ta₂O₅ and/or oxynitrides and/or SiₓN_{y} and/or SiO₂ and/or SiON and/or amorphous silicon and/or SiC,
the impervious sealing means are coated after the electrical connection support has been placed near the first end face of the unit stack,
at least part of the impervious sealing means is coated before the electrical connection support is placed near the first end face of the unit stack,
at least the primary impervious cover layer is coated before the electrical connection support is placed near the first end face of the unit stack, then the additional impervious cover layer is coated after said electrical connection support has been placed near said first end face.

The method further comprises:
supplying a frame (105) intended to form a plurality of supports (5),
placing said frame near the first end face of a plurality of unit stacks, these stacks being arranged in a plurality of lines and/or a plurality of rows, and
making at least one cut, in particular a plurality of cuts in the longitudinal direction and/or lateral direction of these stacks, so as to form a plurality of electrochemical devices.

Finally, the invention has the object of an electric energy-consuming device comprising a body and a battery above, said battery being capable of supplying electric energy to said electric energy-consuming device, and said electric connection support of said battery being fastened to said body.

It should firstly be noted that the applicant must be credited with identifying certain drawbacks of the prior art in terms of imperviousness. In particular, the applicant has observed that the interface between the encapsulation system and the contact members forms a critical zone. In essence, this zone forms a preferred gateway for various components that are capable of interfering with the correct operation of the electrodes, in particular water molecules. However, in the prior art, the aforementioned interface is unsatisfactory in terms of imperviousness in that it does not form a sufficient barrier against the aforementioned components.

Conversely, according to the invention, the presence of the impervious cover layer overcomes the drawbacks of the prior art. More specifically, this cover layer defines a particularly effective barrier against the aforementioned detrimental components. Moreover, this cover layer advantageously has a relatively substantial thickness. In this way, mechanical breakage phenomena, to which deposits made by ALD, for example, are subject, can be prevented. The invention thus procures a stiff and impervious encapsulation, in particular preventing water vapour from passing at the interface between the encapsulation system and the contact members.

In a particularly advantageous manner, the battery according to the invention includes a metal foil in the second electrical connection layer thereof. As understood within the scope of the invention, such a metal foil advantageously has a “free-standing” structure. In other words, it is produced “ex situ”, then brought into the vicinity of the first layer above. This metal foil can be obtained, for example, by rolling; in this case, the rolled foil can have undergone a final soft annealing, either partially or completely.

The metal foil, used in the invention, can also be obtained by other methods, in particular by electrochemical deposition or electroplating. In such a case, it can typically be carried out “ex situ” as described hereinabove. Alternatively, it can also be carried out “in situ”, i.e. directly on the first layer above. In any case, once produced, this metal foil has a controlled thickness.

It should be noted that the layer comprising copper metal obtained from a nanoparticle-filled ink, which is described in International Patent Publication No. WO 2019/215 410 mentioned hereinabove, is in no way a metal foil as understood within the scope of the invention. More specifically, the layer disclosed in this prior art document does not meet any of the above criteria.

Typically, the thickness of this metal foil is comprised between 5 and 200 micrometres. Moreover, this metal foil is advantageously perfectly dense and electrically conductive. By way of non-limiting examples, this metal foil can be made from the following materials: nickel, stainless steel, copper, molybdenum, tungsten, vanadium, tantalum, titanium, aluminium, chromium and the alloys comprising same.

The use of such a metal foil in combination with the coating layer reinforces the aforementioned technical effects, in particular in terms of imperviousness. It should be noted in this respect that such a metal foil has a much higher imperviousness than that provided by the deposition of metal nanoparticles. More specifically, the films obtained by sintering contain more point defects, making them less hermetically sealed.

Moreover, the surfaces of the metal nanoparticles are often covered with a thin oxide layer, the nature whereof limits the electrical conductivity thereof. Conversely, the use of a metal foil improves airtightness and electrical conductivity.

Furthermore, the use of a metal foil allows a wide range of materials to be used. This ensures that the chemical composition in contact with the anodes and cathodes respectively is electrochemically stable. Conversely, in the prior art, the choice of available materials for forming nanoparticles is relatively limited.

The drying step mentioned in the accompanying claims in particular ensures that the metal foil adheres to at least the anode connection zone and/or at least the cathode connection zone, preferably to at least the contact surface comprising at least the anode connection zone and/or to at least the contact surface comprising at least the cathode connection zone.

### DRAWINGS

The accompanying figures diagrammatically show multi-layer batteries encapsulated according to different embodiments of the invention. They correspond to cross-sections perpendicular to the thickness of the layers.

FIG. 1 shows a battery comprising a single unit battery; the encapsulation system comprises three different layers.

FIG. 2 shows a battery comprising a stack of four unit batteries; the encapsulation system comprises three different layers.

FIG. 3 shows a battery comprising a stack of four unit batteries; the encapsulation system comprises three successions of two different layers.

FIGS. 4A and 4B are perspective views showing stacks alternating anode and cathode foils, included in two alternative embodiments of a method for manufacturing a battery according to the invention.

FIG. 5 is a longitudinal, sectional view showing the battery in FIG. 1, further including a conductive support.

FIG. 6 is a longitudinal, sectional view showing an alternative embodiment to that shown in FIG. 5.

FIG. 7 is an overhead view showing a frame allowing for the simultaneous production of a plurality of batteries according to FIG. 5 or 6.

FIG. 8 is a front view, similar to that of FIG. 5, showing a step of producing the battery shown in FIG. 5.

FIG. 9 is an overhead view showing cuts made in the frame in FIG. 7, in order to obtain a plurality of batteries.

FIG. 10 is a front view showing the integration of the battery in FIG. 5 into an energy-consuming device.

FIG. 11 is a front view, similar to that of FIG. 10, showing an alternative embodiment to that shown in FIG. 10, in particular with regard to the structure of the conductive support.

FIG. 12 is a perspective, exploded view of the different components of the conductive support in FIG. 11.

### DESCRIPTION

The present invention applies to a so-called unit electrochemical cell, i.e. a stack successively comprising an anode current collector, an anode layer, a layer of an electrolyte material or a separator impregnated with an electrolyte, a cathode layer and a cathode current collector. Said collector is also referred to herein as a “collecting substrate”, i.e. an anode collecting substrate and a cathode collecting substrate.

The present invention further applies to a battery including a stack of a plurality of unit cells.

The encapsulation representing one key feature of the invention is described here.

After producing the stack of the layers which make up the battery, and after the mechanical and/or heat treatment step thereof for consolidating the stack (this treatment can be a thermocompression treatment, comprising the simultaneous application of a high pressure and a high temperature), this stack is encapsulated by depositing an encapsulation system to protect the battery cell from the atmosphere. The encapsulation system must be chemically stable, able to withstand a high temperature and impermeable to the atmosphere to fulfil its function as a barrier layer.

The stack can be covered with an encapsulation system comprising: optionally, a first dense and insulating cover layer, preferably selected from parylene, parylene F, polyimide, epoxy resins, acrylates, fluoropolymers, silicone, polyamide, sol-gel silica, organic silica and/or a mixture thereof, deposited on the stack of anode and cathode foils; and optionally, a second cover layer consisting of an electrically insulating material, deposited by atomic layer deposition on the stack of anode and cathode foils or on said first cover layer; and according to an essential feature, at least a third impervious cover layer, preferably having a water vapour permeance (WVTR) of less than 10⁻⁵ g/m²·d, this third cover layer being made of a ceramic material and/or a low melting point glass, preferably a glass with a melting point below 600° C., deposited at the outer periphery of the stack of anode and cathode foils or of the first cover layer, with the understanding that this sequence of at least one second cover layer and at least one third cover layer can be repeated z times, where z 1, and deposited at the outer periphery of at least the third cover layer, and that the last layer of the encapsulation system is an impervious cover layer, preferably having a water vapour permeance (WVTR) of less than 10⁻⁵ g/m²·d, which is made of a ceramic material and/or a low melting point glass. This sequence can be repeated z times, where z 1. It has a barrier effect, which increases as the value of z increases.

The water vapour permeance can be measured using a method that is the object of the U.S. Pat. No. 7,624,621 and that is also described in the publication “Structural properties of ultraviolet cured polysilazane gas barrier layers on polymer substrates” by A. Mortier et al. published in Thin Solid Films 6+550 (2014) 85-89.

Typically, the first cover layer, which is optional, is selected from the group consisting of: silicones (for example deposited by impregnation or by plasma-enhanced chemical vapour deposition from hexamethyldisiloxane (HMDSO)), epoxy resins, polyimide, polyamide, poly-para-xylylene (also called poly(p-xylylene), but better known as parylene), and/or a mixture thereof. When a first cover layer is deposited, it protects the sensitive elements of the battery from the environment thereof. The thickness of said first cover layer is preferably comprised between 0.5 μm and 3 μm. This first cover layer is especially useful when the electrolyte and electrode layers of the battery have porosities: it acts as a planarisation layer, which also has a barrier effect. By way of example, this first layer is capable of lining the surface of the microporosities opening out onto the surface of the layer, to close off the access thereto.

In this first cover layer, different parylene variants can be used. Parylene C, parylene D, parylene N (CAS 1633-22-3), parylene F or a mixture of parylene C, D, N and/or F can be used. Parylene is a dielectric, transparent, semi-crystalline material with high thermodynamic stability, excellent resistance to solvents and very low permeability. Parylene also has barrier properties. Parylene F is preferred within the scope of the present invention.

This first cover layer is advantageously obtained from the condensation of gaseous monomers deposited by chemical vapour deposition (CVD) on the surfaces of the stack of the battery, which results in a conformal, thin and uniform covering of all of the accessible surfaces of the stack. This first cover layer is advantageously stiff; it cannot be considered to be a flexible surface.

The second cover layer, which is also optional, is formed by an electrically insulating material, preferably an inorganic material. It is deposited by atomic layer deposition (ALD), by PECVD, by HDPCVD (high density plasma chemical vapour deposition) or by ICP CVD (inductively coupled plasma chemical vapour deposition) in order to obtain a conformal covering of all of the accessible surfaces of the stack previously covered with the first cover layer. The layers deposited by ALD are mechanically very fragile and require a stiff bearing surface to fulfil their protective role. The deposition of a fragile layer on a flexible surface would result in the formation of cracks, causing this protective layer to lose integrity. Furthermore, the growth of the layer deposited by ALD is influenced by the nature of the substrate. A layer deposited by ALD on a substrate having zones of different chemical natures will have inhomogeneous growth, which can cause this protective layer to lose integrity. For this reason, this optional second layer, where present, preferably bears against said optional first layer, which ensures a chemically homogeneous growth substrate.

ALD deposition techniques are particularly well suited for covering surfaces with a high roughness in a completely impervious and conformal manner. They allow for the production of conformal layers, free of defects such as holes (so-called “pinhole-free” layers) and represent very good barriers. The WVTR thereof is extremely low. The WVTR (water vapour transmission rate) is used to evaluate the water vapour permeance of the encapsulation system. The lower the WVTR, the more impervious the encapsulation system. The thickness of this second layer is advantageously chosen as a function of the desired level of imperviousness to gases, i.e. the desired WVTR, and depends on the deposition technique used, chosen in particular from among ALD, PECVD, HDPCVD and ICP CVD.

Said second cover layer can be made of a ceramic material, vitreous material or glass-ceramic material, for example in the form of an oxide, of the Al₂O₃ or Ta₂O₅ type, a nitride, a phosphate, an oxynitride or a siloxane. This second cover layer preferably has a thickness comprised between 10 nm and 10 μm, preferably between 10 nm and 50 nm.

This second cover layer deposited by ALD, PECVD, HDPCVD (high density plasma chemical vapour deposition) or ICP CVD (inductively coupled plasma chemical vapour deposition) on the first cover layer firstly makes it possible to render the structure impervious, i.e. to prevent water from migrating inside the object, and secondly makes it possible to protect the first cover layer, which is preferably made of parylene F, from the atmosphere, in particular from air and moisture, and from thermal exposure in order to prevent the degradation thereof. This second cover layer thus improves the life of the encapsulated battery.

Said second cover layer can also be deposited directly on the stack of anode and cathode foils, i.e. in the case where said first cover layer has not been deposited.

The third cover layer must be impervious, which means that it preferably has a water vapour permeance (WVTR) of less than 10⁻⁵ g/m²·d. This third cover layer is formed by a ceramic material and/or a low melting point glass, preferably a glass having a melting point below 600° C., deposited at the outer periphery of the stack of anode and cathode foils or of the first cover layer. The ceramic and/or glass material used in this third layer is advantageously chosen from among:
a low melting point glass (typically >600° C.), preferably SiO₂—B₂O₃; Bi₂O₃—B₂O₃, ZnO—Bi₂O₃—B₂O₃, TeO₂—V₂O₅, PbO—SiO₂,
oxides, nitrides, oxynitrides, SiₓN_{y}, SiO₂, SiON, amorphous silicon or SiC.

These glasses can be deposited by moulding or dip coating.

The ceramic materials are advantageously deposited by PECVD or preferably by HDPCVD or ICP CVD at a low temperature; these methods allow a layer with good imperviousness to be deposited.

The stack thus coated is then cut by any suitable means along the D′n and Dn cutting lines, so as to expose the anode and cathode connection zones and obtain unit batteries.

Contact members (electrical contacts) are added where the cathode connection or respectively anode connection zones are apparent. These contact zones are preferably disposed on opposite sides of the stack of the battery to collect the current (lateral current collectors). The contact members are disposed at least on the cathode connection zone and at least on the anode connection zone, preferably on the face of the coated and cut stack comprising at least the cathode connection zone and on the face of the coated and cut stack comprising at least the anode connection zone.

Preferably, the contact members are constituted, in the vicinity of the cathode and anode connection zones, by a stack of layers successively comprising a first electrical connection layer comprising a material filled with electrically conductive particles, preferably a polymeric resin and/or a material obtained by a sol-gel method, filled with electrically conductive particles and more preferably a graphite-filled polymeric resin, and a second layer consisting of a metal foil disposed on the first layer.

The first electrical connection layer allows the subsequent second electrical connection layer to be fastened while providing “flexibility” at the connection without breaking the electrical contact when the electric circuit is subjected to thermal and/or vibratory stresses.

The second electrical connection layer is advantageously a metal foil. This second electrical connection layer is used to provide the batteries with lasting protection against moisture. In general, for a given thickness of material, metals make it possible to produce highly impervious films, more impervious than ceramic-based films and even more impervious than polymer-based films, which are generally not very impervious to the passage of water molecules. It increases the calendar life of the battery by reducing the WVTR at the contact members.

Typically, each first layer is fastened respectively to the anode or cathode terminations by adhesive bonding. With this in mind, a conductive adhesive layer can be used. In particular, two layers of conductive adhesives can be used, the properties whereof are different from one another. These layers are “successive”, i.e. the first layer covers the terminations, whereas the second layer covers this first layer. Advantageously, these two conductive adhesives can have different physical-chemical properties, in particular different wettabilities.

Typically, the metal foil described hereinabove is fastened onto the first layer by adhesive bonding, more precisely by means of a conductive adhesive which must be electrochemically stable when in contact with the electrodes. This metal foil, bonded using a conductive adhesive, improves the imperviousness of the terminations and reduces the electrical resistance thereof. This technical effect is noteworthy, regardless of the method for manufacturing this foil.

Advantageously, a third electrical connection layer comprising a conductive ink can be deposited on the second electrical connection layer; the purpose thereof is to reduce the WVTR, thus increasing the life of the battery.

The contact members allow the electrical connections to be made alternating between positive and negative at each of the ends. These contact members enable parallel electrical connections to be made between the different battery elements. For this purpose, only the cathode connections protrude at one end, and the anode connections are available at another end.

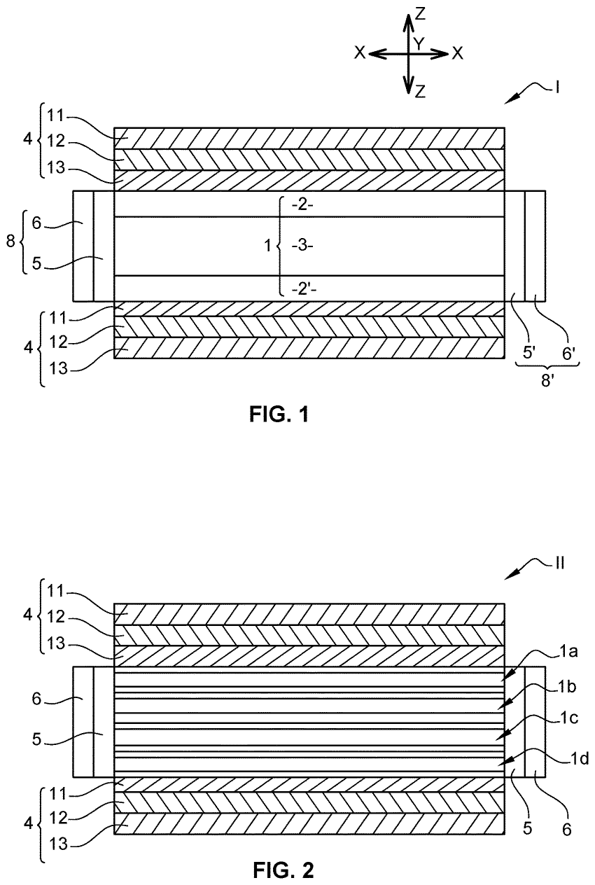

FIGS. 1 to 3 will now be described in order to illustrate the invention, which figures diagrammatically show multi-layer batteries encapsulated according to different embodiments of the invention. They correspond to cross-sections perpendicular to the thickness of the layers.

The orthogonal coordinate system XYZ has been used, wherein:
the axis XX is a first horizontal axis, i.e. it is included in the plane of the different layers making up the stack. Moreover, this axis XX is referred to as transverse, i.e. it extends laterally with reference to the foil. In particular, it is perpendicular to the plane of the contact members, which will be described hereinbelow,
the axis YY is a second horizontal axis, also included in the plane of the layers of the stack. This axis YY is referred to as sagittal, i.e. it extends from the back to the front of the foil. In particular, it is parallel to the plane of the contact members,
finally, the axis ZZ extends vertically, while being perpendicular to each of the above axes. It is also referred to as the frontal axis.

FIG. 1 shows a battery I according to a first embodiment of the invention. This battery comprises a single unit cell 1. More specifically, the unit cell 1 is formed by an anode layer 2, an electrolyte layer 3, and a cathode layer 2′. The encapsulation system 4 comprises three different layers, disposed one on top of the other: a first layer 11, as explained hereinabove, then a second cover layer 12, as explained hereinabove, and finally a third cover layer 13, as explained hereinabove.

Here, this encapsulation system covers four of the six faces of the battery (if it is represented as a rectangular parallelepiped). Each of the two faces not covered by the encapsulation system, which are preferably laterally opposite one another, defines at least one electrical connection zone; the first face not covered by the encapsulation system defining an anode connection zone, and; the second face not covered by the encapsulation system defining a cathode connection zone in order to prevent any risk of a short-circuit.

This battery further comprises contact members, which are denoted as a whole by the respective reference numerals 8 and 8′. As described hereinabove, each contact member comprises a first electrical connection layer 5 or 5′ and a second electrical connection layer 6 or 6′.

FIG. 2 shows a battery II according to a second embodiment of the invention. This battery II comprises a stack of four unit cells 1a, 1b, 1c, 1d. The encapsulation system 4 comprises three different layers, as explained with reference to FIG. 1. The contact members 8 and 8′ are similar to those described hereinabove with reference to FIG. 1.

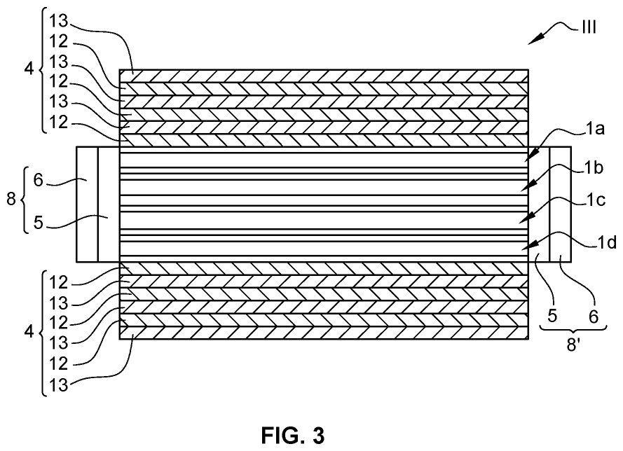

FIG. 3 shows a battery III according to a third embodiment of the invention. This battery comprises a stack of four unit cells as described with reference to FIG. 2. The encapsulation system 4 comprises three successions of two different layers, i.e. a second cover layer 12, as explained hereinabove, and a third cover layer 13 as explained hereinabove. Finally, the contact members 8 and 8′ are similar to those described hereinabove with reference to FIG. 1.

It should be noted that the batteries I, II and III in FIGS. 1 to 3 must comply with the conditions regarding imperviousness, which is a key criterion of the invention. For this purpose, the contact members 8 and 8′ are made of a conductive material that meets this imperviousness criterion. Such a material is, for example, a conductive glass, in particular of the type filled with a metal powder (for example filled with particles (and preferably nanoparticles) of chromium, aluminium, copper and other metals that are electrochemically stable at the electrode's operating potential).

Advantageously, as is known per se, a plurality of unit stacks, such as that described hereinabove, can be produced simultaneously. This increases the efficiency of the overall method for manufacturing the batteries according to the invention. In particular, a stack having large dimensions can be produced, formed by an alternating succession of cathode and respectively anode strata, or foils.

The physical-chemical structure of each anode or cathode foil, which is of a type known, for example, in the French Patent Publication No. FR 3 091 036 filed by the applicant, does not fall within the scope of the invention and will be described only briefly. Each anode or respectively cathode foil comprises an anode active layer or respectively a cathode active layer. Each of these active layers can be solid, i.e. they can have a dense or porous nature. Furthermore, in order to prevent electrical contact between two adjacent foils, a layer of electrolyte or a separator impregnated with a liquid electrolyte is disposed on at least one of these two foils, in contact with the opposite foil. The electrolyte layer or the separator impregnated with a liquid electrolyte, not shown in the figures describing the present invention, is sandwiched between two foils of opposite polarity, i.e. between the anode foil and the cathode foil.

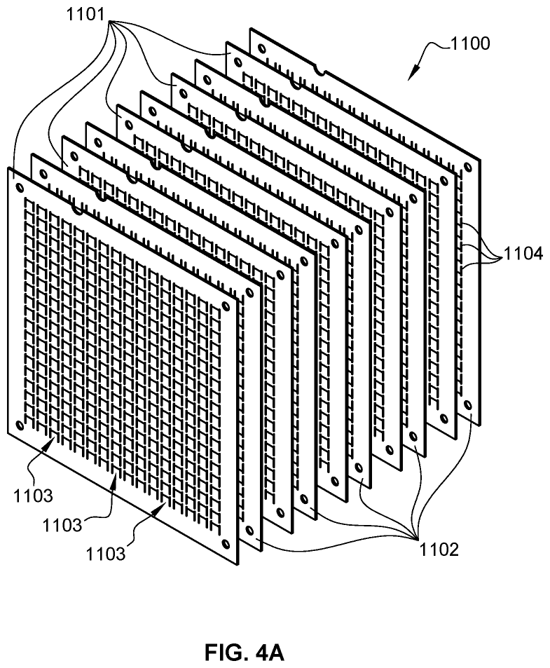

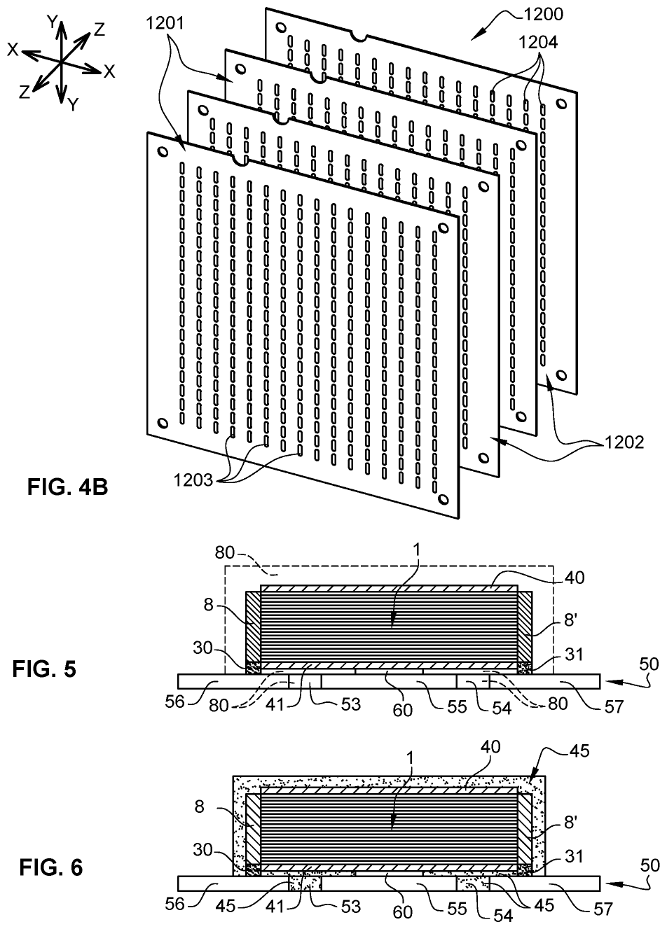

These strata are indented so as to define so-called empty zones which will allow for the separation between the different final batteries. Within the scope of the present invention, different shapes can be assigned to these empty zones. As already proposed by the Applicant in the French Patent Publication No. FR 3 091 036, these empty zones can be H-shaped. The accompanying FIG. 4A shows the stack 1100 between anode foils or strata 1101 and cathode foils or strata 1102. As shown in this figure, cuts are made in these different foils to create said H-shaped anode 1103 and respectively cathode 1104 empty zones.

Alternatively, these free zones can also be I-shaped. The accompanying FIG. 4B shows the stack 1200 between anode foils or strata 1201 and cathode foils or strata 1202. As shown in FIG. 4B, cuts are made in these different foils to create said I-shaped anode 1203 and respectively cathode 1204 empty zones.

Preferably, once the manufacture of the different unit stacks is complete, each anode and each cathode of a given battery comprises a respective primary body, separated from a respective secondary body by a space free of any electrode material, electrolyte and/or current-conducting substrate. According to an additional alternative embodiment, not shown, the empty zones can be provided such that the shapes thereof are different to a H or an I shape, such as a U shape. Nonetheless, H or I shapes are preferred. Said empty zones can be filled with a resin during the manufacturing method.

FIG. 5 and the following figures show additional advantageous alternative embodiments, wherein the above battery further includes a support. These figures diagrammatically show the stack 1, the frontal encapsulation regions 40 and 41, and the contact members 8 and 8′. The aforementioned support 50, which is generally planar, typically has a thickness of less than 300 μm, preferably less than 100 μm. This support is advantageously made of an electrically conductive material, typically a metal material, in particular aluminium, copper, or stainless steel, which can be coated to improve the weldability property thereof by a thin layer of gold, nickel and tin. The so-called front face of the support is respectively given the reference numeral 51 and faces the stack 9, and the opposite, rear face is given the reference numeral 52.

This support is perforated, i.e. it has spaces 53 and 54 delimiting a central base plate 55 and two opposite lateral strips 56 and 57. The different regions 55, 56 and 57 of this support are thus electrically insulated from one another. In particular, as will be seen hereafter, the lateral strips 56 and 57 form regions which are electrically insulated from one another and which can be connected to contact members belonging to the battery. In the example shown, electrical insulation is achieved by providing empty spaces 53 and 54 which, as will be seen hereafter, are filled with a stiffening material. Alternatively, these spaces can be filled with a non-conductive material, for example polymers, ceramics, or glasses.

In the example shown, the support and the stack are connected to one another by a layer 60. The latter is typically formed by means of a non-conductive adhesive, in particular of the epoxy or acrylate type. Alternatively, the support and the stack can be rigidly secured to one another by means of a weld, not shown. The thickness of this layer 60 is typically comprised between 5 μm and 100 μm, in particular equal to about 50 μm. According to the main plane of the support 50, this layer at least partially covers the aforementioned spaces 53 and 54, so as to insulate the anode and cathode contact members from one another as described in detail hereinbelow. Moreover, pads 30 and 31 of a conductive adhesive allow the contact members to be fastened to the support 5, while ensuring electrical continuity.

According to a first possibility, corresponding to the embodiment shown in FIG. 5, the material forming the contact members 8 and 8′ is capable of fulfilling an impervious sealing function according to the above criterion. For this purpose, this material typically belongs to the list presented hereinabove with reference to the description of the first three figures. In such a case, there is no need to provide an additional encapsulation. More specifically, thanks to the presence of the impervious contact members and encapsulation, the unit stack of anodes and cathodes is protected against the penetration of potentially detrimental gases.

According to a second possibility, corresponding to the embodiment shown in FIG. 6, the material forming the contact members 8 and 8′ is not impervious as understood within the scope of the invention. In such a case, the battery advantageously comprises an additional so-called encapsulation layer 45, shown in solid lines in FIG. 6. This additional layer provides the stack with the desired imperviousness, such that it is “re-encapsulated”. Advantageously the material of this layer 45 is given the same definition as the last layer of the encapsulation system. As a result, this layer 45 advantageously has a water vapour permeance (WVTR) of less than 10-5 g/m2·d, while being made of a ceramic material and/or a low melting point glass. In this embodiment, the “impervious cover” layer is thus formed by the last layer of the initial encapsulation system, which constitutes a so-called primary impervious cover layer, and by the additional layer 45, which constitutes a so-called additional impervious cover layer.

In order to guarantee the key criterion regarding imperviousness, this additional encapsulation layer 45 firstly covers the contact members 8 and 8′. Moreover, it extends into the intermediate space made between the initial encapsulation layer 41 and the opposite face of the support 50. Finally, it also extends into the free spaces 53 and 54 in the support. In the bottom part of this FIG. 6, the reference numeral 45 has been given three more times to these specific zones. As a result, components that are detrimental to the proper functioning of the battery cannot access the unit stack of the anodes and cathodes. In other words, the invention prevents any potential “gateway” for these detrimental components.

According to a third possibility, not shown, only the unit stack is firstly placed on the support, with the interposition of the non-conductive adhesive layer. The lateral faces of the stack are then covered with the contact members. With this in mind, the unit stack, already provided with these contract members yet without its encapsulation system, can also be placed on the support thereof. Finally, the encapsulation system is deposited, while taking care to ensure total imperviousness, as described hereinabove.

Finally, according to one advantageous embodiment of the invention, the battery can be further equipped with a stiffening system. This can firstly be applied to the battery as shown in FIG. 5, which has impervious contact members. This stiffening system is thus denoted as a whole by the reference numeral 80. In such a case, the stiffening material covers the top face of the battery, as well as the lateral contact members. This stiffening material also advantageously fills the intermediate space between the layer 41 and the support 50, as well as the free spaces 53, 54 in the support. In order to show this filling, the reference numeral 80 has been used several times in the different zones occupied by the stiffening material.

In a manner not shown, the stiffening material can also be applied to the battery in FIG. 6, which has contact members that are not impervious. In such a case, the stiffening material covers the additional encapsulation system 45 at the top and lateral edges thereof. It should be noted that this stiffening material can be intimately bonded to the encapsulation material 45, in the free spaces 53, 54, as well as in the intermediate space between the layer 41 and the support 50.

This stiffening system 80 can be made of any material that provides this mechanical stiffness function. With this in mind, a resin can be chosen for example, which can consist of a simple polymer or a polymer filled with inorganic fillers. The polymer matrix can be from the family of epoxies, acrylates or fluorinated polymers for example, and the fillers can be formed by particles, flakes or glass fibres.

Advantageously, this stiffening system 80 can provide an additional moisture barrier function. With this in mind, a low melting point glass can be chosen, for example, thus ensuring the mechanical strength and providing an additional moisture barrier. This glass can be, for example, from the SiO₂—B₂O₃; Bi₂O₃—B₂O₃, ZnO—Bi₂O₃—B₂O₃, TeO₂—V₂O₅ or PbO—SiO₂ family.

Typically, the stiffening system 80 is much thicker than the encapsulation system. With reference to FIG. 5 the smallest thickness of this stiffening system, at the covering of the front face of the stack, is denoted by the reference E80. Advantageously, this thickness E80 is comprised between 20 and 250 μm, typically equal to about 100 μm. The presence of an additional stiffening system brings additional advantages. This stiffening system thus provides a mechanical and chemical protection function, optionally combined with an additional gas barrier function.

The integration of the battery according to the invention onto the support 50, as described hereinabove, can be achieved by individually placing each unit stack on the support thereof. Nonetheless, a plurality of batteries are advantageously manufactured simultaneously, each integrating such a support.

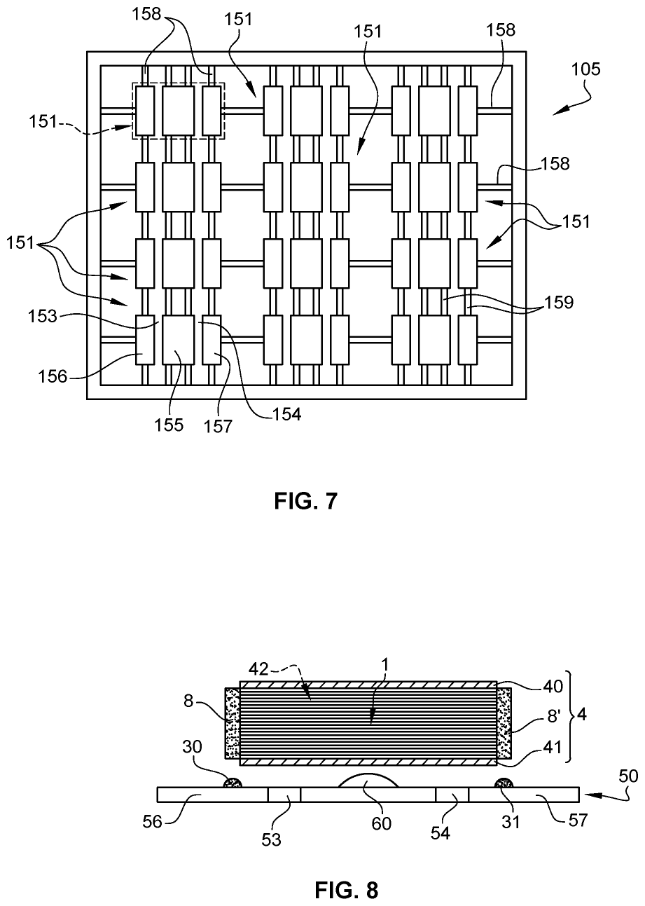

With this in mind, such a simultaneous manufacturing method is shown in FIGS. 7 to 9. In order to implement this method, a support frame 105 is advantageously used, and which is intended to form a plurality of supports 50. This frame 104, which is shown at a large scale in FIG. 7, has a peripheral border 150, as well as a plurality of preforms 151, each of which allows one respective battery to be manufactured. In the example shown, twelve mutually identical preforms can be seen, divided into three lines and four columns. Alternatively, a frame with a different number of such preforms can be used.

Each preform comprises a central area 155, intended to form the base plate 55, and two lateral blocks 156 and 157 intended to form the strips 56 and 57 respectively. The area and the blocks are separated from one another by grooves 153 and 154, which are intended to form the spaces 53 and 54. The different preforms are fixed, both in relation to one another and to the peripheral edge by means of different horizontal rods 158 and vertical rods 159 respectively.

In this embodiment, each preform 151 receives an already encapsulated battery, which is thus in accordance with that shown in FIG. 1. In terms of manufacturing methods, a dose 106 of non-conductive adhesive is deposited on each area 155 to form the layer 6, and doses 130 and 131 of conductive adhesive are deposited to form the pads 30 and 31. The encapsulated stack is then placed in contact with the support so as to form the adhesive layer 60 and the pads 30 and 31, allowing this stack to be mutually fastened to the support.

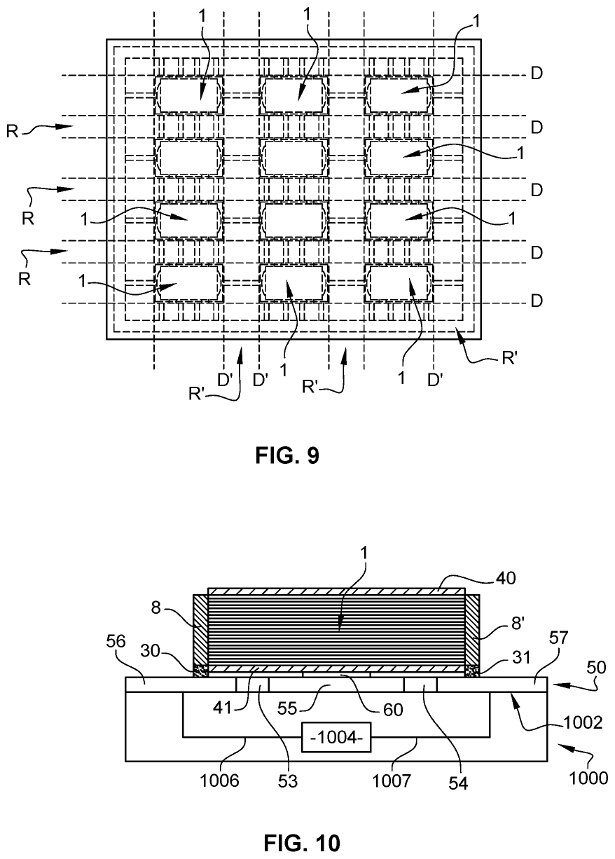

Finally, as shown in FIG. 9, a cut is made in the frame 150, on which the different components of the plurality of batteries have been disposed. The different cutting lines are marked with dotted lines and given the reference D for cuts in the longitudinal dimension of the batteries and the reference D′ for cuts in the lateral dimension thereof. It should be noted that, in the two dimensions of the frame, certain zones R and R′ are intended to be discarded.

According to an alternative embodiment, not shown, the electrochemical device according to the invention can include one or more additional electronic components. Such a component can, for example, be of the LDO (“low dropout regulator”) type. Typically, production of a mini-circuit with a complex electronic function can be envisaged. With this in mind, an RTC (“real time clock”) module or an energy harvesting module can be used. In this embodiment, the one or more electronic components are advantageously covered by the same encapsulation system as that protecting the unit stack.

In operation, in a conventional manner, electrical energy is stored at the unit stack. This energy is transmitted to the conductive regions 55 and 56 of the support 50 via the contact members and via the conductive adhesive pads 30 and 31. Since these conductive regions are insulated from one another, there is no risk of a short-circuit. This electrical energy is then directed from the regions 56 and 57 to an energy-consuming device of any appropriate type.

In FIG. 10, this energy-consuming device is represented diagrammatically and is denoted by the reference numeral 1000. It comprises a body 1002, on which the lower face of the support rests. The mutual fastening between this body 1002 and the support 50 is achieved by any appropriate means. It should be noted that, in FIG. 10, the device 1000 integrates the battery shown in FIG. 5, the contact members whereof are impervious. According to an alternative embodiment, not shown, the battery in FIG. 6 can also be combined with the energy-consuming device 1000. In such a case, as explained hereinabove, it must be ensured that the additional encapsulation material 45 makes the unit stack of the anodes and cathodes perfectly impervious. Reference is made in this respect to the description given hereinabove, in particular with regard to the different locations of the reference numeral 45 in FIG. 6.

The device 1000 further comprises an energy-consuming element 1004, as well as connection lines 1006, 1007 electrically connecting the regions 56, 57 of the support 50 to this element 1004. Control thereof can be provided by a component of the battery itself, and/or by a component, not shown, belonging to the device 1000. By way of non-limiting examples, such an energy-consuming device can be an electronic circuit of the amplifier type, an electronic circuit of the clock type (such as a real time clock (RTC) component), an electronic circuit of the volatile memory type, an electronic circuit of the static random access memory (SRAM) type, an electronic circuit of the microprocessor type, an electronic circuit of the watchdog timer type, a component of the liquid crystal display type, a component of the LED (light emitting diode) type, an electronic circuit of the voltage regulator type (such as a low-dropout regulator circuit (LDO)), or an electronic component of the CPU (central processing unit) type.

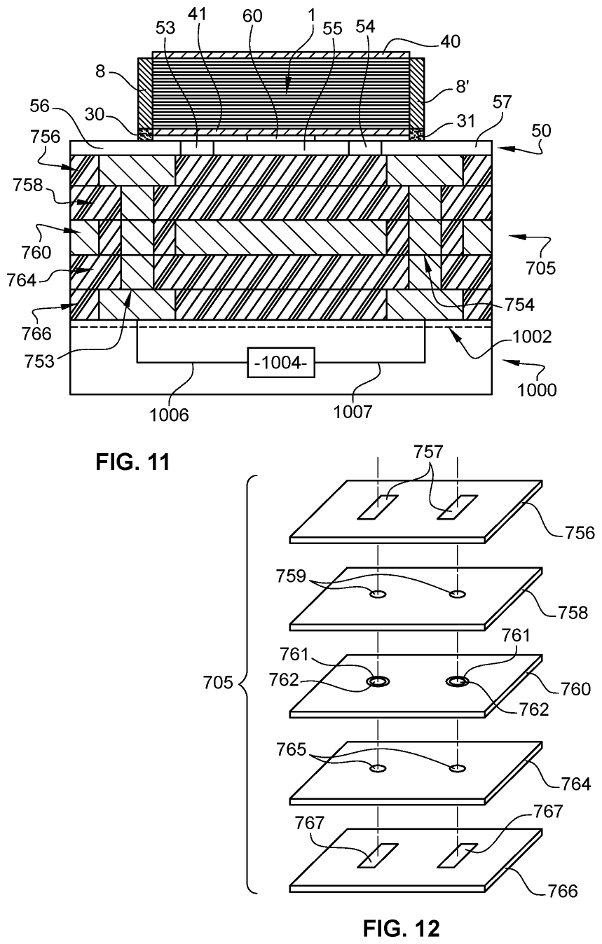

An alternative embodiment will now be described with reference to FIGS. 11 and 12, wherein the conductive support 750 is of the multi-layer type, as opposed to the aforementioned support 50, which is of the single-layer type. Furthermore, this support 750 is of the solid type, as opposed in particular to the metal grid hereinabove which is of the perforated type. As shown in FIG. 11, the support 750 is formed by layers, for example made of a polymer material. These layers extend one below the other, the main plane thereof being substantially parallel to the plane of the layers forming the stack 1 described hereinabove. The structure of this support is thus similar to that of a printed circuit board (PCB).

FIGS. 11 and 12 show, from top to bottom, a layer 756 on which the stack of the battery will be deposited. This layer 756, which is mainly made of a polymer material, such as epoxy resin, is provided with two inserts 757. These are made of a conductive material, in particular a metal material, and are designed to cooperate with the anode and respectively the cathode contacts of the battery. It should be noted that these inserts 757 are insulated from one another, thanks to the epoxy resin of the layer 756.

Immediately below the layer 756 is a layer 758, also made of a polymer material such as an epoxy resin. This layer 758 is provided with 2 inserts 759, made of a conductive material, which are brought into electrical contact with the first inserts 757. As with the layer 756, these inserts 759 are insulated from one another.

A median layer 760 is then present, which is significantly different from the layers 756 and 758 described hereinabove. More specifically, this layer 760 is made of a conductive material, typically similar to that forming the inserts 757 and 759 described hereinabove. This layer is equipped with two ring-shaped inserts 761, which are made of an insulating material, in particular an epoxy resin as described hereinabove. These inserts 761 receive, in the hollow central part thereof, discs 762 made of a conductive material, which are placed in contact with the adjacent conductive inserts 759. It should be noted that these conductive discs 762 are insulated from one another via the rings 761.

Finally, bottom layers 764 and 766 in FIGS. 11 and 12 are present, which are respectively identical to the layers 758 and 756 described hereinabove. The layer 764 is equipped with 2 inserts 765, in contact with the discs 762, whereas the bottom layer 766 is provided with 2 inserts 767, in contact with the aforementioned inserts 765. The different conductive inserts 757, 759, 762, 765 and 767 define conductive paths denoted by the reference numerals 753, 754, which electrically connect the opposing end faces of the support 705. These paths are insulated from one another, either by the layers 756, 758, 764 and 766 or by the discs 761.

In this embodiment, the stiffening system can be different from that 80 of the first embodiment. A protective film 780 can in particular be deposited by means of a lamination step. Such a film, which has barrier properties, is for example made of polyethylene terephthalate (PET) incorporating inorganic multi-layers; such a product that may be suitable for this application, is commercially available from the company 3M under the reference Ultra Barrier Film 510 or Ultra Barrier Solar Films 510-F. Such a stiffening system, using films obtained by rolling, can however be used in other applications, in addition to those shown in FIG. 11.

FIG. 11 further shows the integration, on an energy-consuming device 1000, of the support 705, the stack 702, the conductive pads 730 and 740, the encapsulation 707 and the film 708. As with the first embodiment, the energy generated at the stack 702 is transmitted, via the contact members 730 and 740, to the upper inserts 757. This energy is then transmitted along the connection paths 753, 754 described hereinabove, to the energy-consuming device 1000.

In the most general structure thereof, the multi-layer support can be formed of only two separate layers, one below the other. These layers define conductive paths, similar to the conductive paths 753, 754 described hereinabove. There are specific advantages to this particular embodiment shown with reference to FIG. 11. More specifically, the multi-layer support such as that denoted by the reference numeral 750 has a very small thickness, advantageously less than 100 μm. This support further benefits from a particularly satisfactory bending strength, with a view to the integration thereof on a flexible electronic circuit.

The invention is not limited to the examples described and illustrated.

According to a first alternative embodiment, not shown, each current-collecting substrate can be perforated, i.e. it can have at least one through-opening. Advantageously, the transverse dimension of each perforation (or opening) is comprised between 0.02 mm and 1 mm. Moreover, the void fraction of each perforated substrate is comprised between 10% and 30%. This means that, for a given surface area of this substrate, between 10% and 30% of this surface area is occupied by the perforations.

The technical purpose of these perforations or openings is as follows: the first layer deposited on one of the two faces of the substrate will bond, inside the openings, against the first layer deposited on the other of the two faces of the substrate. This improves the quality of the deposits, in particular the adhesion of the layers in contact with the substrate. More specifically, during the drying and sintering operations, the aforementioned layers undergo slight shrinkage, i.e. a slight decrease in the longitudinal and lateral dimensions thereof, whereas the dimensions of the substrate are substantially unvarying. This tends to create shear stresses at the interface between the substrate and each layer, thus reducing the quality of the adhesion; this stress increases as the thickness of the layers increases.

Under these conditions, providing a perforated substrate significantly improves the quality of this adhesion. In essence, the layers situated on opposite faces of this substrate tend to weld to one another inside the different perforations. This allows the deposition thickness of the layers to be increased, even though they no longer contain organic binders after annealing. This alternative embodiment also allows the battery power to be increased. It is particularly well suited to use with ultra high-power electrodes of the thick mesoporous type.

The method according to the invention is particularly adapted to the manufacture of solid-state batteries, i.e. batteries whose electrodes and electrolyte are solid and do not comprise a liquid phase, even impregnated in the solid phase.

The method according to the invention is particularly adapted to the manufacture of batteries considered to be quasi-solid-state comprising at least one separator impregnated with an electrolyte. Said separator is preferably a porous inorganic layer having:
a porosity, preferably mesoporous, that is greater than 30%, preferably comprised between 35% and 50%, and more preferably between 40% and 50%, and
pores with an average diameter D₅₀ of less than 50 nm.

The separator is often understood to be sandwiched between the electrodes. In the present example embodiment, this is a ceramic or glass ceramic filter deposited on at least one of the electrodes and sintered to produce a solid assembly of the batteries. The fact that a liquid is nano-compressed inside this separator gives the final battery quasi-solid properties.

The thickness of the separator is advantageously less than 10 μm, preferably comprised between 3 μm and 16 μm, more preferably between 3 μm and 6 μm, even more preferably between 2.5 μm and 4.5 μm, so as to reduce the final thickness of the battery without weakening the properties thereof. The pores of the separator are impregnated with an electrolyte, preferably with a lithium-ion carrying phase such as liquid electrolytes or an ionic liquid containing lithium salts. The “nano-confined” or “nano-entrapped” liquid in the porosities, and in particular in the mesoporosities, can no longer escape. It is bound by a phenomenon referred to herein as “absorption in the mesoporous structure” (which does not seem to have been described in the literature within the context of lithium-ion batteries) and it can no longer escape, even when the cell is placed in a vacuum. Such a battery is thus considered to be a quasi-solid-state battery.

The method according to the invention, and the encapsulation system, can in particular be applied to any type of thin-film battery, in particular to any type of lithium-ion battery.

These lithium-ion batteries can be solid-state, multi-layer, lithium-ion batteries, quasi-solid-state, multi-layer, lithium-ion batteries and can in particular be solid-state, multi-layer, lithium ion microbatteries. More generally, these lithium-ion batteries can in particular use anode layers, electrolyte layers and cathode layers such as those described in the International Patent Publication No. WO 2013/064777 within the scope of a microbattery, i.e. anode layers made from one or more of the materials described in claim 13 of this document, cathode layers made from one or more of the materials described in claim 14 of this document, and electrolyte layers made from one or more of the materials described in claim 15 of this document.

The battery according to the invention can be a lithium-ion microbattery, a lithium-ion mini-battery, or a high-power lithium-ion battery. In particular, it can be designed and dimensioned to have a capacity of less than or equal to about 1 mA h (commonly known as a “microbattery”), to have a power of greater than about 1 mA h up to about 1 A h (commonly known as a “mini-battery”), or to have a capacity of greater than about 1 A h (commonly known as a “high-power battery”). Typically, microbatteries are designed to be compatible with methods for manufacturing microelectronics.

The batteries of each of these three power ranges can be produced:

with layers of the “solid-state” type, i.e. without impregnated liquid or paste phases (said liquid or paste phases can be a lithium-ion conductive medium, capable of acting as an electrolyte), or

with layers of the mesoporous “solid-state” type, impregnated with a liquid or paste phase, typically a lithium-ion conductive medium, which spontaneously penetrates the layer and no longer emerges therefrom, so that the layer can be considered to be quasi-solid, or

with impregnated porous layers (i.e. layers with a network of open pores which can be impregnated with a liquid or paste phase, which gives these layers wet properties).

1-28. (canceled)

29. A battery, comprising:
at least one unit cell successively including an anode current-collecting substrate, an anode layer, a layer of an electrolyte material or of a separator impregnated with an electrolyte, a cathode layer, and a cathode current-collecting substrate;
at least one anode contact member to make the electrical contact between at least the at least one unit cell and an external conductive element;
a first contact surface defining at least one anode connection zone;
at least one cathode contact member to make the electrical contact with an external conductive element;
a second contact surface defining at least one cathode connection zone; and
an encapsulation system covering at least part of an outer periphery of said at least one unit cell, the encapsulation system including:
a first cover layer deposited on the at least one unit cell, the first cover layer chosen from the group consisting of parylene, parylene F, polyimide, epoxy resins, silicone, polyamide, sol-gel silica, organic silica and/or a mixture thereof,
a second cover layer deposited by atomic layer deposition on the at least one unit cell or the first cover layer, the second cover layer being composed of an electrically insulating material, and
a third impervious cover layer deposited at the outer periphery of the at least one unit cell or the first cover layer, the third impervious cover layer having a water vapour permeance of less than 10⁻⁵ g/m²·d, the third impervious cover layer being composed of a ceramic material and/or a glass having a melting point below 600° C.,
wherein a succession of said second cover layer and said third impervious cover layer is repeated z times, where z 1 and deposited at the outer periphery of at least the third impervious cover layer, and the third impervious cover layer is a final layer of the encapsulation system.

30. The battery of claim 29, wherein the third impervious cover layer, preferably having a water vapour permeance (WVTR) of less than 10⁻⁵ g/m²·d, has a thickness comprised between 1 μm and 50 μm, more preferably between 1 μm and 10 μm, even more preferably between 1 μm and 5 μm.

31. The battery of claim 29, wherein each of the at least one anode contact member and the at least one cathode contact member comprises:
a first electrical connection layer, disposed on at least the anode connection zone and at least the cathode connection zone, the first electrical connection layer comprising a material filled with electrically conductive particles, and
a second electrical connection layer comprising a metal foil disposed on the first layer of material filled with electrically conductive particles.

32. The battery of claim 31, wherein the metal foil is a free-standing metal foil applied to said first electrical connection layer.

33. The battery of claim 31, wherein each of the at least one anode contact member and the at least one cathode contact member comprises a third layer disposed on the second electrical connection layer, the third layer comprising a conductive ink.

34. The battery of claim 31, further comprising:
an electrical connection support comprising a single-layer metal grid or a single-layer silicon interlayer provided near an end face of a unit cell in the at least one unit cell, the electrical connection support being composed at least in part of a conductive material;
an electrical insulator enabling two distant regions forming respective electrical connection paths of the electrical connection support to be insulated from one another,
wherein said at least one anode contact member facilitates an electrically connection between a first lateral face of each unit cell and a first electrical connection path, and said at least one cathode contact member facilitates an electrically connection between a second lateral face of each unit cell and a second electrical connection path.

35. The battery of claim 34, wherein the electrical connection support comprises:
a single-layer metal grid or a single-layer silicon interlayer, or
a multi-layer printed circuit board having a plurality of layers disposed one below the other.

36. The battery of claim 34, wherein the third impervious cover layer comprises:
a primary impervious cover layer that does not cover the at least one anode contact member and the at least one cathode contact member, respectively, and
a fourth impervious cover layer that covers in part or in whole the at least one anode contact member and the at least one cathode contact member, respectively, and at least partially covering the electrical connection support.

37. A method of manufacturing a battery, the method comprising:
a) supplying at least one anode foil that includes at least one anode current-collecting substrate foil coated with an anode layer, and optionally coated with a layer of an electrolyte material or a separator impregnated with an electrolyte;
b) supplying at least one cathode foil that includes at least one current-collecting substrate foil coated with a cathode layer, and optionally coated with a layer of an electrolyte material or a separator impregnated with an electrolyte;
c) producing a stack by alternating at least one anode foil and at least one cathode foil to successively obtain the stack of at least one anode current-collecting substrate, at least one anode layer, at least one layer of an electrolyte material or of a separator impregnated with an electrolyte, at least one cathode layer, and at least one cathode current-collecting substrate,
d) heat treating and/or mechanically compressing the stack to form a consolidated stack,
e) encapsulating the consolidated stack by depositing:
at least one first cover layer on the heat treated and/or mechanically compressed consolidated stack, the at least one first cover layer being chosen from the group consisting of parylene, parylene F, polyimide, epoxy resins, silicone, polyamide, sol-gel silica, organic silica and/or a mixture thereof,
at least one second cover layer by atomic layer deposition on the heat treated and/or mechanically compressed consolidated stack or the first cover layer, the second layer being composed of an electrically insulating material, and
at least one third impervious cover layer at an outer periphery of the heat treated and/or mechanically compressed consolidated stack or the first cover layer, the third impervious cover layer having a water vapour permeance of less than 10⁻⁵ g/m²·d, and being composed of a ceramic material and/or a glass with a melting point below 600° C., wherein the deposit in sequence of the at least one second cover layer and the at least one third impervious cover layer is repeated z times, where z 1 in a manner such that the at least one third impervious cover layer is a final layer,
f) making two cuts to form a cut stack exposing at least an anode connection zone and a cathode connection zone; and
g) producing an anode contact member and a cathode contact member.

38. The method of claim 37, wherein the production of the anode contact member and the cathode contact member comprises:
depositing, on at least the anode connection zone and at least the cathode connection zone, a first electrical connection layer composed of polymeric resin filled with electrically conductive particles and/or a material obtained by a sol-gel method filled with electrically conductive particles;
drying and then polymerizing the polymeric resin filled with electrically conductive particles and/or the material obtained by a sol-gel method filled with electrically conductive particles; and
depositing a second electrical connection layer on the first electrical connection layer, said second electrical connection layer being a metal foil or a metal ink.

39. The method of claim 38, wherein the metal foil is formed by rolling, and then applied to the first electrical connection layer.

40. The method of claim 38, wherein the metal foil is formed directly by electroplating, either ex situ or in situ with respect to the first metal connection layer.

41. The method of claim 38, further comprising, producing the anode contact member and the cathode contact member:
h) depositing a conductive ink on at least the anode connection zone and the cathode connection zone coated with the first electrical connection layer and the second electrical connection layer.

42. The method of claim 37, wherein the at least one second cover layer is deposited by HDPCVD or ICP CVD at a low temperature.

43. The method of claim 37, wherein the at least one second cover layer comprises oxides and/or nitrides and/or Ta₂O₅ and/or oxynitrides and/or SixNy and/or SiO₂ and/or SiON and/or amorphous silicon and/or SiC.

44. The method of claim 37, further comprising:
placing an electrical connection support comprising a single-layer metal grid or a single-layer silicon interlayer near an end face of the stack unit cell, the electrical connection support being composed at least in part of a conductive material,
wherein the at least one third impervious cover layer is deposited after placing the electrical connection support.

45. The method of claim 37, further comprising:
placing an electrical connection support comprising a single-layer metal grid or a single-layer silicon interlayer near an end face of the stack unit cell, the electrical connection support being composed at least in part of a conductive material,
wherein at least part of the at least one third impervious cover layer is deposited before placing the electrical connection support.

46. The method of claim 37, further comprising:
placing an electrical connection support comprising a single-layer metal grid or a single-layer silicon interlayer near an end face of the stack unit cell, the electrical connection support being composed at least in part of a conductive material,
wherein:
the third impervious cover layer comprises a primary impervious cover layer that does not cover the at least one anode contact member and the at least one cathode contact member, respectively, and a fourth impervious cover layer that covers in part or in whole the at least one anode contact member and the at least one cathode contact member, respectively, and at least partially covering the electrical connection support, and
at least the primary impervious cover layer is deposited before placing the electrical connection support, and the fourth impervious cover layer is deposited after placing the electrical connection support.

47. The method of claim 37, further comprising:
forming a plurality of supports via a support frame;
placing said support frame near the first end face of a plurality of unit stacks arranged in a plurality of lines and/or a plurality of rows;
making at least one cut in a longitudinal direction and/or a lateral direction of the unit stacks to form a plurality of electrochemical devices.

48. An electric energy-consuming device, comprising:
a body; and
a battery to supply electric energy to the electric energy-consuming device, the battery including:
at least one unit cell successively including an anode current-collecting substrate, an anode layer, a layer of an electrolyte material or of a separator impregnated with an electrolyte, a cathode layer, and a cathode current-collecting substrate;
at least one anode contact member to make the electrical contact between at least the at least one unit cell and an external conductive element;
a first contact surface defining at least one anode connection zone;
at least one cathode contact member to make the electrical contact with an external conductive element;
a second contact surface defining at least one cathode connection zone;
an electrical connection support, fastened to said body and arranged near an end face of a unit cell, the electrical connection support composed at least in part of a conductive material, and
an encapsulation system covering at least part of an outer periphery of said at least one unit cell, the encapsulation system including:
a first cover layer deposited on the at least one unit cell, the first cover layer chosen from the group consisting of parylene, parylene F, polyimide, epoxy resins, silicone, polyamide, sol-gel silica, organic silica and/or a mixture thereof,
a second cover layer deposited by atomic layer deposition on the at least one unit cell or the first cover layer, the second cover layer being composed of an electrically insulating material, and
a third impervious cover layer deposited at the outer periphery of the at least one unit cell or the first cover layer, the third impervious cover layer having a water vapour permeance of less than 10⁻⁵ g/m²·d, the third impervious cover layer being composed of a ceramic material and/or a glass having a melting point below 600° C.,
wherein a succession of said second cover layer and said third impervious cover layer is repeated z times, where z≥1, and deposited at the outer periphery of at least the third impervious cover layer, and the third impervious cover layer is a final layer of the encapsulation system.
